(19) United States
(12) Patent Application Publication
(10) Pub. No.: US 2018/0120986 A1
(43) Pub. Date: May 3, 2018

(54) TOUCH SENSOR-EQUIPPED DISPLAY DEVICE

(71) Applicant: SHARP KABUSHIKI KAISHA, Osaka (JP)

(72) Inventors: SHINICHI MIYAZAKI, Sakai City (JP); TAKATOSHI KIRA, Sakai City (JP)

(21) Appl. No.: 15/553,183

(22) PCT Filed: Feb. 22, 2016
(86) PCT No.: PCT/JP2016/055043

§ 371 Date: Aug. 24, 2017

(30) Foreign Application Priority Data
Feb. 24, 2015 (JP) 2015-033443

(51) Int. Cl. G06F 3/041; G06F 3/044

(52) U.S. Cl. CPC G06F 3/0412; G06F 2203/04103; G06F 3/044

(57) ABSTRACT

A touch sensor-equipped display device is provided in which dividing lines for dummy electrodes provided between touch detection electrodes are not recognizable. The touch sensor-equipped display device includes: a display panel that includes a display function layer interposed between a first substrate and a second substrate, the display function layer including a plurality of display pixels arranged in matrix; a plurality of touch drive electrodes arranged between the first substrate and the second substrate so as to be arrayed in a first direction, each of the touch drive electrodes extending in a second direction that intersects with the first direction at a right angle; a plurality of touch detection electrodes arranged on a surface of the first substrate, the surface being on an opposite side with respect to the touch drive electrodes, so as to be arrayed in the second direction, each of the touch detection electrodes extending in the first direction; and a dummy electrode arranged between adjacent ones of the touch detection electrodes. A slit is provided in the dummy electrode, the slit being repeatedly bent in a zigzag shape, while extending in the first direction. The dummy electrode is divided by, as a dividing line, a line obtained by extending either a first edge or a second edge, the first edges and the second edges forming the slit in the zigzag shape, so that the dummy electrode should not be provided across a plurality of the touch drive electrodes.

### TECHNICAL FIELD

The present invention relates to a touch sensor-equipped display device.

### BACKGROUND ART

Patent Document 1 discloses a touch sensor-equipped display device that includes touch drive electrodes and touch detection electrodes. In this touch sensor-equipped display device, touch drive electrodes extend in a direction parallel to a direction in which scanning signals for driving pixel electrodes extend, the touch detection electrodes extend in a direction vertical to the direction in which scanning signals extend. Further, between adjacent ones of the touch detection electrodes, dummy electrodes are provided so that the touch detection electrodes become unnoticeable to human eye.

Here, in a case where the dummy electrodes are provided across a plurality of the touch drive electrodes, there is a possibility that a signal supplied to the touch drive electrodes could interfere via the dummy electrodes. The dummy electrodes, therefore, are divided at least not to be provided across a plurality of the touch drive electrodes.

### PRIOR ART DOCUMENT

### Patent Document

Patent Document 1: JP-A-2014-130537

### SUMMARY OF THE INVENTION

### Problem to be Solved by the Invention

However, if the dummy electrodes are divided by lines parallel to the direction in which the touch drive electrodes extend, there is a possibility that during a period while the power source of the display device is OFF, or during a period while a dark image such as a black image is displayed, the dividing lines for the dummy electrodes can be visually recognized under a light source of approximately parallel light such as the sun light of the like.

It is an object of the present invention to provide a touch sensor-equipped display device in which dividing lines of the dummy electrodes are difficult to visually recognize.

### Means to Solve the Problem

A touch sensor-equipped display device in one embodiment of the present invention includes a display panel that includes: a first substrate; a second substrate opposed to the first substrate; and a display function layer interposed between the first substrate and the second substrate, the display function layer including a plurality of display pixels arranged in matrix. The touch sensor-equipped display device further includes: a plurality of touch drive electrodes arranged between the first substrate and the second substrate so as to be arrayed in a first direction, each of the touch drive electrodes extending in a second direction that intersects with the first direction at a right angle; a plurality of touch detection electrodes arranged on a surface of the first substrate, the surface being on an opposite side with respect to the touch drive electrodes, so as to be arrayed in the second direction, each of the touch detection electrodes extending in the first direction; and a dummy electrode arranged between adjacent ones of the touch detection electrodes, wherein a slit is provided in the dummy electrode, the slit being repeatedly bent in a zigzag shape, while extending in the first direction, and the dummy electrode is divided by, as a dividing line, a line parallel with either first edges or second edges, the first edges and the second edges forming the slit in the zigzag shape, so that the dummy electrode should not be provided across a plurality of the touch drive electrodes arrayed in the first direction.

### Effect of the Invention

According to the present invention, dividing lines that divide the dummy electrode are difficult to recognize, during a period while the power source of the display device is OFF, or during a period while a dark image such as a black image is displayed.

### BRIEF DESCRIPTION OF DRAWINGS

FIG. 1 illustrates a cross-sectional configuration of a touch sensor-equipped display device in one embodiment.

FIG. 2 is a plan view illustrating the touch sensor-equipped display device in one embodiment.

FIG. 3 is a schematic cross-sectional view of the liquid crystal panel with a touch sensor function.

FIG. 4 is an enlarged plan view illustrating a plan-view configuration in a display section of an array substrate that composes the liquid crystal panel with a touch sensor function.

FIG. 5 is an enlarged plan view illustrating a plan-view configuration in a display section of a CF substrate that composes the liquid crystal panel with a touch sensor function.

FIG. 6 is a plan view illustrating an arrangement configuration of touch drive electrodes and touch detection electrodes.

FIG. 7 is a diagram for explaining a shape of a slit provided in the dummy electrode.

FIG. 8 illustrates dividing lines of dummy electrodes in a conventional touch sensor-equipped display device.

FIG. 9 illustrates that an edge portion of a conductive film composing the dummy electrode is tilted in a taper shape.

FIG. 10 is an image diagram illustrating edge patterns of dummy electrodes in a conventional touch sensor-equipped display device in which dummy electrodes are divided by lines parallel to a direction in which touch drive electrodes extend, the image diagram illustrating that the edge patterns of the dummy electrodes are visible when viewed in a direction from a lower end of the display device.

FIG. 11 illustrates dividing lines of dummy electrodes in the touch sensor-equipped display device in the present embodiment.

FIG. 12 is a diagram for explaining the shapes of a slit provided in touch detection electrodes.

FIG. 13 illustrates one exemplary arrangement of color filters.

FIG. 14 is a diagram obtained by superposing the diagram of the touch detection electrode configuration illustrated in FIG. 12 on the diagram of color filter arrangement illustrated in FIG. 13.

FIG. 15A is an enlarged view illustrating a part of the display screen when the entirety of the display screen is in a white color display state, in a case where the arrangement interval “a” for the slits is set to 1.000 time the arrangement interval “b” for the display pixels.

FIG. 15B is an enlarged view illustrating a part of the display screen when the entirety of the display screen is in a white color display state, in a case where the arrangement interval “a” for the slits is set to 1.225 times the arrangement interval “b” for the display pixels.

FIG. 15C is an enlarged view illustrating a part of the display screen when the entirety of the display screen is in a white color display state, in a case where the arrangement interval “a” for the slits is set to 1.250 times the arrangement interval “b” for the display pixels.

FIG. 15D is an enlarged view illustrating a part of the display screen when the entirety of the display screen is in a white color display state, in a case where the arrangement interval “a” for the slits is set to 1.500 times the arrangement interval “b” for the display pixels.

FIG. 15E is an enlarged view illustrating a part of the display screen when the entirety of the display screen is in a white color display state, in a case where the arrangement interval “a” for the slits is set to 1.725 times the arrangement interval “b” for the display pixels.

FIG. 15F is an enlarged view illustrating a part of the display screen when the entirety of the display screen is in a white color display state, in a case where the arrangement interval “a” for the slits is set to 2.000 times the arrangement interval “b” for the display pixels.

FIG. 16A is an enlarged view illustrating a part of the display screen when a black-and-white vertical stripe display is performed, in a case where the arrangement interval “a” for the slits is set to 1.725 times the arrangement interval “b” for the display pixels.

FIG. 16B is an enlarged view illustrating a part of the display screen when a black-and-white chessboard pattern display is performed, in a case where the arrangement interval “a” for the slits is set to 1.725 times the arrangement interval “b” for the display pixels.

FIG. 16C is an enlarged view illustrating a part of the display screen when an RGB chessboard pattern display is performed, in a case where the arrangement interval “a” for the slits is set to 1.725 times the arrangement interval “b” for the display pixels.

FIG. 17A is a diagram for explaining a method for displaying a black-and-white vertical stripe display.

FIG. 17B is a diagram for explaining a black-and-white chessboard pattern display.

FIG. 17C is a diagram for explaining a black-and-white chessboard pattern display.

### MODE FOR CARRYING OUT THE INVENTION

A touch sensor-equipped display device in one embodiment of the present invention includes a display panel that includes: a first substrate; a second substrate opposed to the first substrate; and a display function layer interposed between the first substrate and the second substrate, the display function layer including a plurality of display pixels arranged in matrix. The touch sensor-equipped display device further includes: a plurality of touch drive electrodes arranged between the first substrate and the second substrate so as to be arrayed in a first direction, each of the touch drive electrodes extending in a second direction that intersects with the first direction at a right angle; a plurality of touch detection electrodes arranged on a surface of the first substrate, the surface being on an opposite side with respect to the touch drive electrodes, so as to be arrayed in the second direction, each of the touch detection electrodes extending in the first direction; and a dummy electrode arranged between adjacent ones of the touch detection electrodes, wherein a slit is provided in the dummy electrode, the slit being repeatedly bent in a zigzag shape, while extending in the first direction, and the dummy electrode is divided by, as a dividing line, a line parallel with either first edges or second edges, the first edges and the second edges forming the slit in the zigzag shape, so that the dummy electrode should not be provided across a plurality of the touch drive electrodes arrayed in the first direction (the first configuration).

According to first configuration, a dividing line that divides the dummy electrode is difficult to recognize, during a period while the power source of the display device is OFF, or during a period while a dark image such as a black image is displayed. This makes it possible to improve appearance of the touch sensor-equipped display device in, for example, a power source OFF state.

In the first configuration, the dummy electrode is divided by, as a dividing line, a line obtained by extending either the first edge or the second edge, the first edges and the second edges forming the slit in the zigzag shape (the second configuration).

According to the second configuration, a line obtained by extending either the first edges or the second edges, the first edges and the second edges forming the slit.

This makes the dividing line more difficult to visually recognize.

### Embodiment

The following describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of a part of constituent members is omitted. Further, the dimension ratios of the constituent members illustrated in the drawings do not necessarily indicate the real dimension ratios.

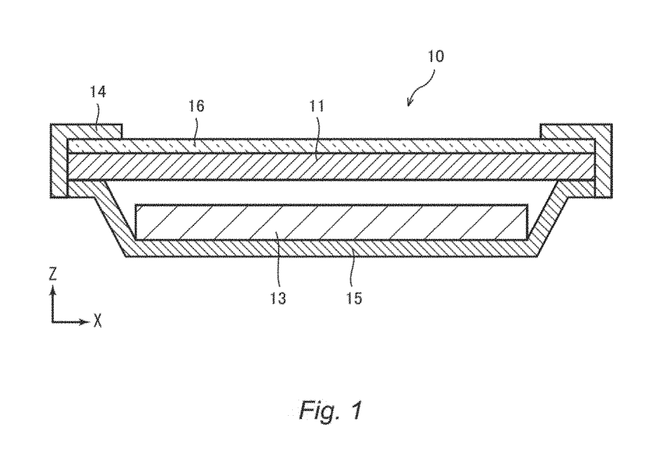

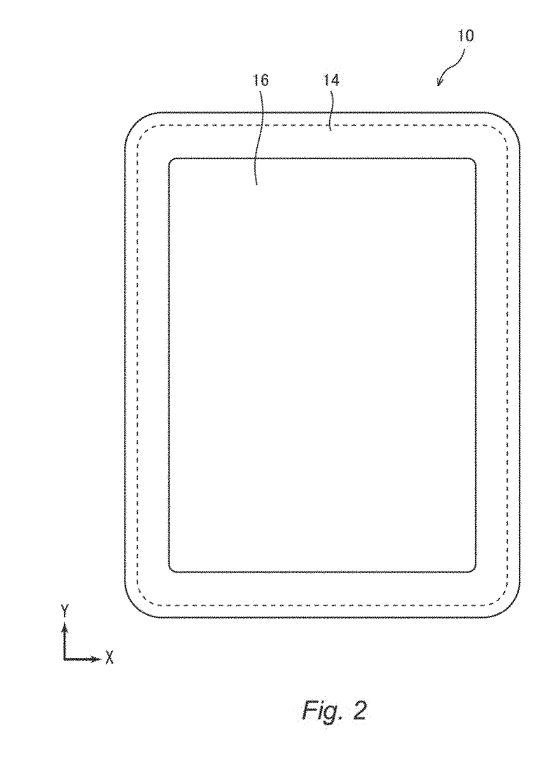

FIG. 1 illustrates a cross-sectional configuration of a touch sensor-equipped display device 10 in one embodiment. FIG. 2 is a plan view illustrating the touch sensor-equipped display device 10 in one embodiment. The touch sensor-equipped display device 10 includes a liquid crystal panel 11 with a touch sensor function, a backlight device (lighting device) 13, a bezel 14, a case 15, and a cover 16. Regarding this touch sensor-equipped display device 10, the side thereof on which the cover 16 is provided is the front side, and the side thereof on which the case 15 is provided is the rear side.

The liquid crystal panel 11 with a touch sensor function has a function of displaying an image, and a touch sensor function of detecting a touched position. More specifically, the liquid crystal panel 11 with a touch sensor function has a configuration that includes: a liquid crystal panel (display panel) that includes a pair of substrates and a display function layer provided between the substrates, the display function layer including a plurality of display pixels provided in matrix; touch drive electrodes provided between the pair of substrates of the liquid crystal panel; and touch detection electrodes provided on a front side of the substrate on the front side of the display panel.

The backlight device 13 is an external light source that emits light toward the liquid crystal panel 11 with a touch sensor function.

The cover 16 is arranged on an outer side of the liquid crystal panel 11 with a touch sensor function so as to protect the liquid crystal panel 11 with a touch sensor function. This cover 16 is made of a material that has excellent impact resistance, for example, tempered glass. The liquid crystal panel 11 with a touch sensor function, and the cover 16, are bonded and integrated with each other with an approximately transparent adhesive (not shown) being interposed therebetween.

The bezel 14 holds the cover 16 and the liquid crystal panel 11 with a touch sensor function together, between the same and the backlight device 13. The bezel 14 is attached to the case 15, and the case 15 houses the backlight device 13.

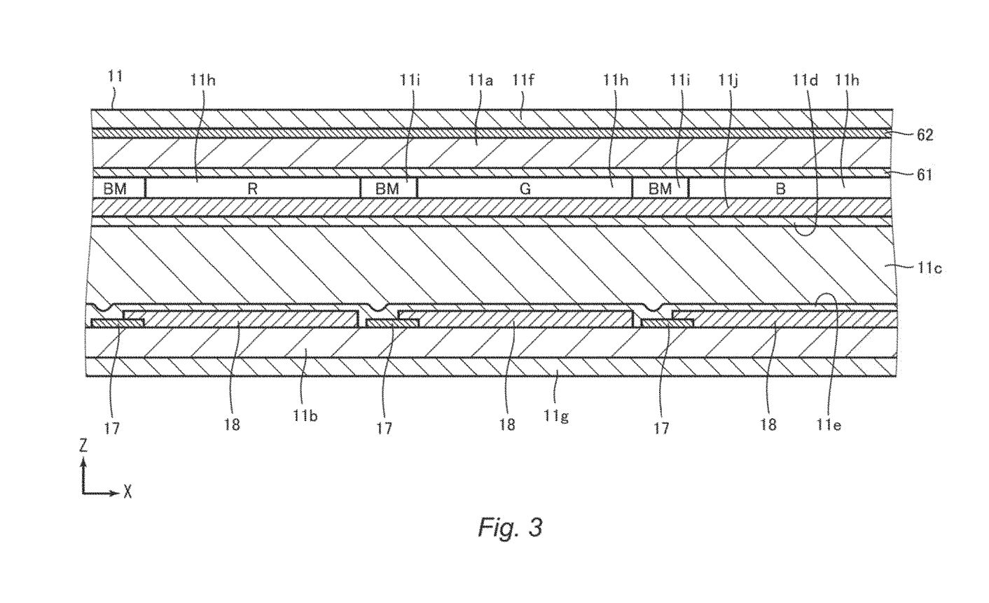

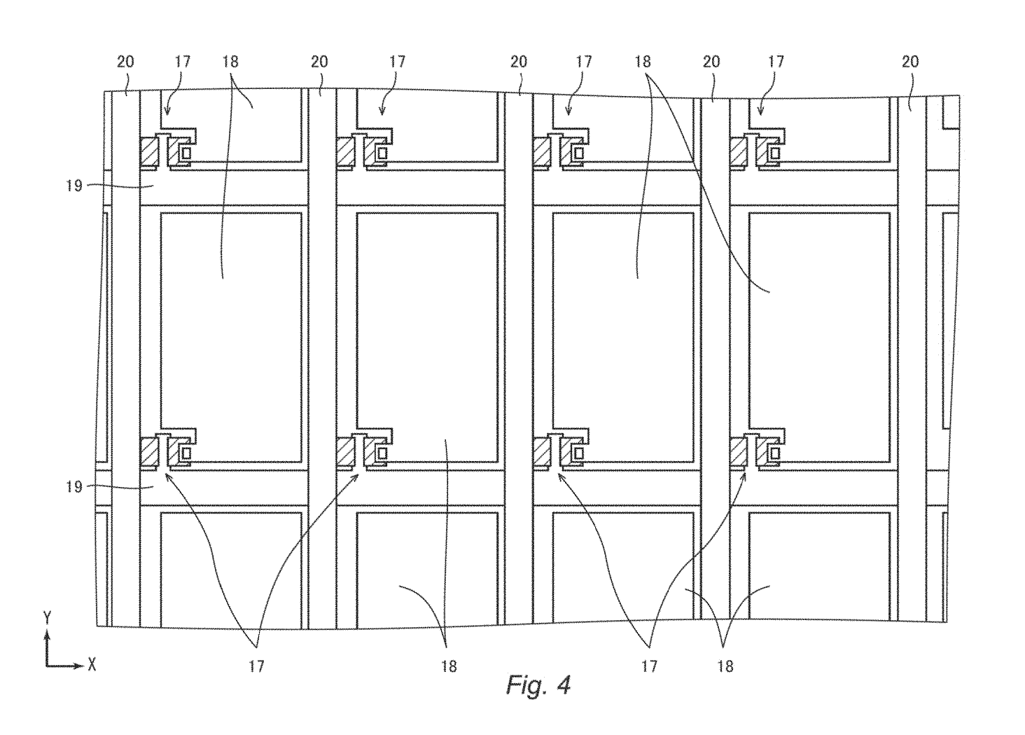

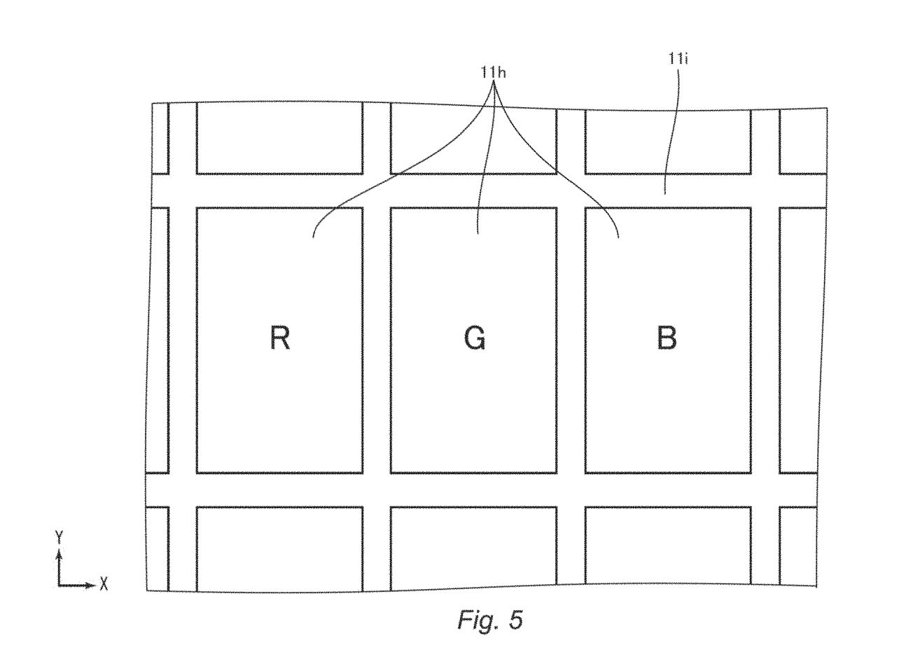

FIG. 3 is a schematic cross-sectional view of the liquid crystal panel 11 with a touch sensor function. FIG. 4 is an enlarged plan view illustrating a plan-view configuration in a display section of an array substrate that composes the liquid crystal panel 11 with a touch sensor function. FIG. 5 is an enlarged plan view illustrating a plan-view configuration in a display section of a CF substrate that composes the liquid crystal panel 11 with a touch sensor function.

The liquid crystal panel 11 with a touch sensor function includes a pair of substrates 11a and 11b that are transparent (that have excellent translucency), and a liquid crystal layer 11c interposed between the substrates 11a and 11b, as illustrated in FIG. 3. The liquid crystal layer 11c contains liquid crystal molecules as a substance whose optical properties change in response to the application of an electric field. The substrates 11a and 11b are bonded with each other with a sealant (not shown) in a state in which a cell gap corresponding to the thickness of the liquid crystal layer 11c is maintained therebetween.

Each of the substrates 11a and 11b includes an approximately transparent glass substrate, and has such a configuration that a plurality of films are laminated on the glass substrate by a known photolithography method or the like. Among the substrates 11a and 11b, the CF substrate (first substrate) 11a is on the front side, and the array substrate (second substrate) 11b is on the rear side (back side).

On the inner side surfaces of the substrates 11a and 11b, alignment films 11d and 11e for aligning the liquid crystal molecules contained in the liquid crystal layer 11c are formed, respectively, as illustrated in FIG. 3. On the outer side surfaces of the substrates 11a and 11b, polarizing plates 11f and 11g are laminated, respectively.

On the inner side surface of the array substrate 11b (the liquid crystal layer 11c side, the side opposed to the CF substrate 11a), a plurality of thin film transistors (TFTs) 17, which are switching elements, and a plurality of pixel electrodes 18, are provided in matrix, as illustrated in FIGS. 3 and 4. Gate lines 19 and source lines 20 forming a lattice pattern are arranged so as to enclose these TFTs 17 and pixel electrodes 18. In other words, at intersections of the gate lines 19 and the source lines 20 forming the lattice pattern, the TFTs 17 and the pixel electrodes 18 are arranged in parallel, so as to be arranged in matrix.

The gate lines 19 and the source lines 20 are connected to the gate electrodes and the source electrodes of the TFTs 17, respectively, and the pixel electrodes 18 are connected to the drain electrodes of the TFTs 17. Further, each pixel electrode 18 is in a portrait oriented rectangular shape when viewed in a plan view, and is formed with a translucent conductive film made of a material having excellent translucency and conductivity, such as indium tin oxide (ITO) or zinc oxide (ZnO).

On the other hand, as illustrated in FIGS. 3 and 5, color filters 11h are provided in matrix on the CF substrate 11a, in such a manner that the color portions in colors of red (R), green (G), blue (B) and the like overlap the pixel electrodes 18 on the array substrate 11b side when viewed in a plan view. Between the respective color portions that form the color filter 11h, a light-shielding layer (black matrix) 11i in a lattice pattern for preventing the color mixing is formed. The light-shielding layer 11i is arranged so as to overlap the above-described gate lines 19 and the source lines 20 when viewed in a plan view. Over an entire surface of the color filters 11h and the light-shielding layer 11i, a counter electrode 11j is provided, which is opposed to the pixel electrodes 18 on the array substrate 11b side.

In this liquid crystal panel 11 with a touch sensor function, as illustrated in FIGS. 3 to 5, one display pixel as a display unit is composed of a set of the color portions in the three colors of R (red), G (green), and B (blue) and the three pixel electrodes 18 opposed to the color portions, respectively. The display pixel is composed of a red color subpixel having a color portion of R, a green color subpixel having a color portion of G, and a blue color subpixel having a color portion of B. These subpixels of the respective colors are arranged side by side repeatedly in the row direction (X axis direction) on the plate surface of the liquid crystal panel 11, thereby forming a pixel group, and a multiplicity of such pixel groups are arrayed in the column direction (Y axis direction). In other words, a plurality of the display pixels are arranged in matrix. In the present embodiment, the subpixels are arranged in a so-called stripe array.

The following describes the touch sensor function. The liquid crystal panel 11 with a touch sensor function includes touch drive electrodes 61 and touch detection electrodes 62 that compose the touch sensor. As illustrated in FIG. 3, the touch drive electrodes 61 are provided on the back side (the liquid crystal layer 11c side) of the CF substrate 11a, and the touch detection electrodes 62 are provided on the front side of the CF substrate 11a. More specifically, the touch drive electrodes 61 are provided between the CF substrate 11a on one hand and the color filters 11h and the light-shielding layer 11i on the other hand. Further, the touch detection electrodes 62 are provided between the CF substrate 11a and the polarizing plate 11f. This touch sensor is of the so-called projection type electrostatic capacitance method, and the detection method thereof is of the mutual capacitance type.

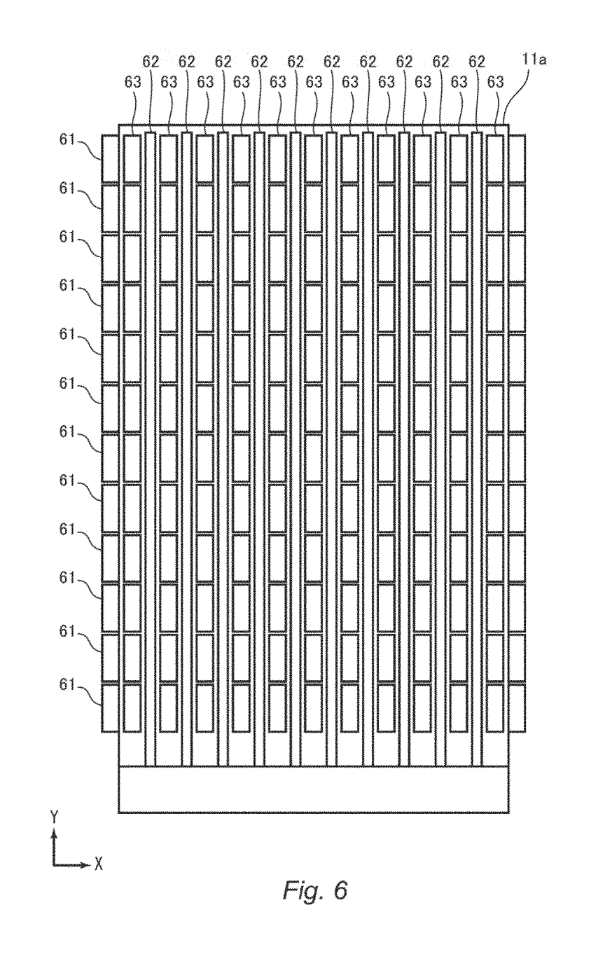

FIG. 6 is a plan view illustrating the arrangement configuration of the touch drive electrodes 61 and the touch detection electrodes 62. A plurality of touch drive electrodes 61 extending in the X axis direction are provided so as to be arrayed in the Y axis direction at predetermined intervals. Further, a plurality of touch detection electrodes 62 extending in the Y axis direction are provided so as to be arrayed in the X axis direction at predetermined intervals. The touch drive electrodes 61 and the touch detection electrodes 62 are formed with translucent conductive films made of a material having excellent translucency and conductivity, such as indium tin oxide (ITO) or zinc oxide (ZnO).

The following simply explains a method for detecting a touched position. The touch drive electrodes 61 are sequentially scanned so that an input signal is input thereto, and output signals output from the touch detection electrodes 62 are detected. When any area of the surface of the touch sensor-equipped display device 10 is touched, the electrostatic capacitance between the touch drive electrode 61 and the touch detection electrode 62 at the touched position changes. Based on an output signal output from the touch detection electrode 62, the position where the electrostatic capacitance has changed is detected, and the detected position is identified as the touched position.

Between the plurality of the touch detection electrodes 62 provided on the front side of the CF substrate 11a, the dummy electrodes 63 are provided. In other words, in each space between adjacent ones of the plurality of touch detection electrodes 62 arrayed in the X axis direction at predetermined intervals, a plurality of dummy electrodes 63 extending in the Y axis direction are provided.

The dummy electrodes 63 are provided for the purpose of preventing the light transmission rate and the like from becoming different between the positions where the touch detection electrodes 62 are provided and the positions where they are not provided, on the front side of the CF substrate 11a. The dummy electrodes 63, therefore, are formed with conductive films made of the same material as that of the touch detection electrodes 62, that is, a material having excellent translucency, such as ITO or ZnO. It should be noted that the dummy electrodes 63 are not connected with other lines or electrodes, and are in an electrically floating state.

The touch detection electrodes 62 and the dummy electrodes 63 have predetermined refractive indices, though they are transparent. In the touch detection electrodes 62 and the dummy electrodes 63, therefore, a plurality of slits are provided so as to make the touch detection electrodes 62 and the dummy electrodes 63 unnoticeable when the touch sensor-equipped liquid crystal display device 10 is viewed.

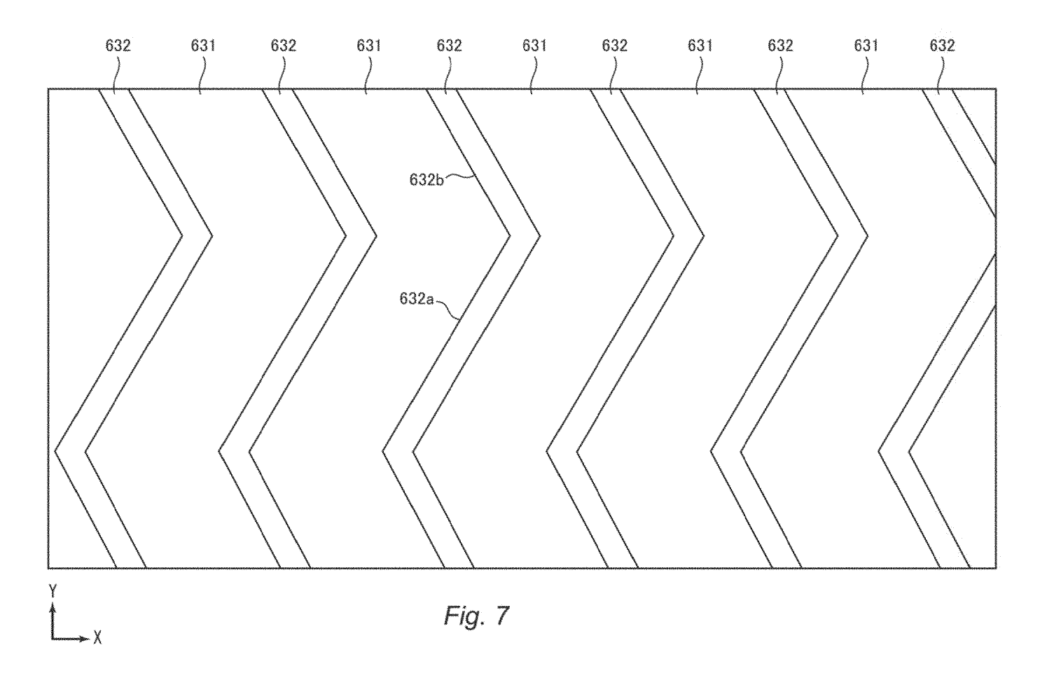

FIG. 7 is a diagram for explaining the shape of slits provided in the dummy electrodes 63. It should be noted that slits in the identical shape are provided in the touch detection electrodes 62.

The dummy electrode 63 is composed of a plurality of electrode portions 631 formed with translucency conductive films and a plurality of slits 632 formed between the electrode portions 631. Each slit 632 is repeatedly bent in a zigzag shape, while, as an entire slit, extending in the Y axis direction. In other words, the slit 632 is composed of first direction linear portions 632a extending in a first direction, and second direction linear portions 632b extending in a second direction that is different from the first direction.

Here, the first direction linear portions 632a and the second direction linear portions 632b have the same width in the X axis direction, and the same length in the Y axis direction.

Here, as illustrated in FIG. 6, a plurality of the touch drive electrodes 61 are provided in the Y axis direction. In a case where the dummy electrode 63 is provided so as to be across a plurality of touch drive electrode 61, there is a possibility that a signal supplied to the touch drive electrode 61 would interfere through the dummy electrodes 63. The dummy electrode 63 is therefore divided so that one dummy electrode 63 should not be provided across a plurality of (at least two) touch drive electrodes 61.

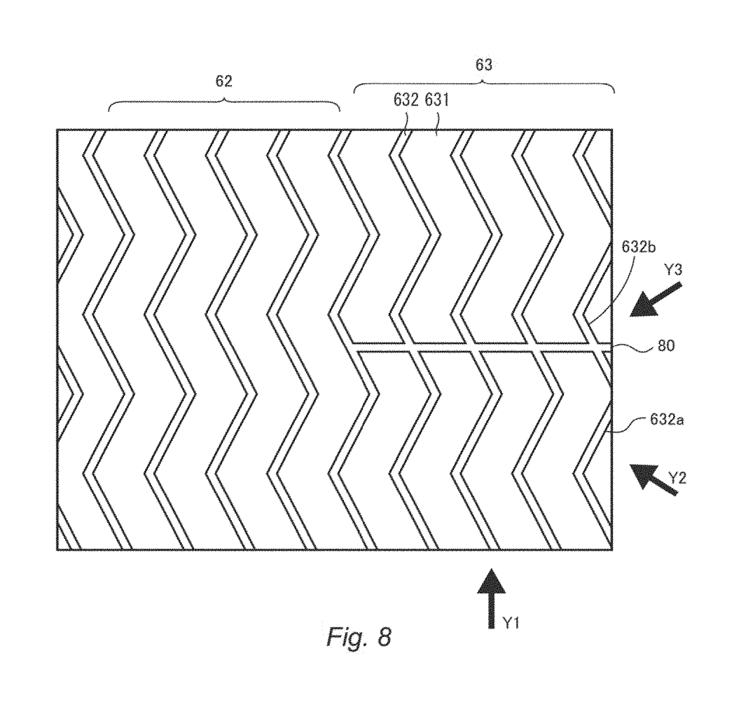

FIG. 8 illustrates dividing lines 80 of the dummy electrodes 63 in a conventional touch sensor-equipped display device. In FIG. 8, the touch detection electrodes 62 are illustrated together with the dummy electrodes 63. In the conventional touch sensor-equipped display device, the dummy electrodes 63 are divided by lines 80 parallel with the direction (X axis direction) in which a plurality of the touch drive electrodes 61 extend, so that each dummy electrode 63 should not be provided across adjacent two of the touch drive electrodes 61.

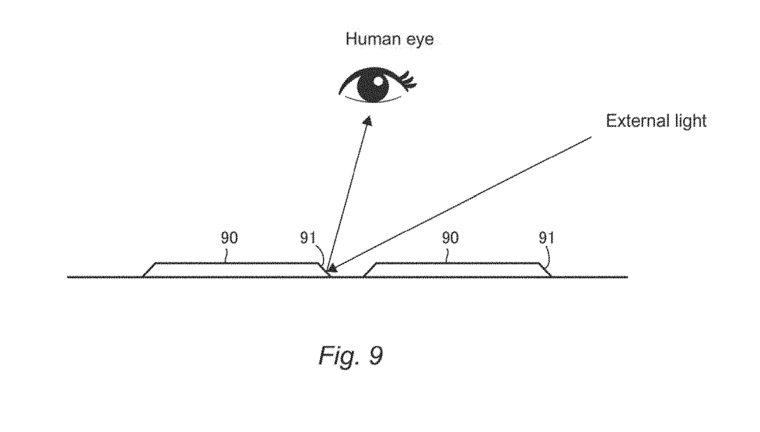

As described above, the dummy electrodes 63 are formed with conductive films made of a material having excellent translucency, such as ITO or ZnO. Since each of edge portions 91 of conductive films 90 is tilted in a taper shape as illustrated in FIG. 9, the pattern edge of the conductive film 90 is recognizable when it is viewed in a specific direction.

In a case where the dummy electrode 63 is divided by the lines 80 parallel with the X axis as illustrated in FIG. 8, therefore, when they are viewed in the direction indicated by the arrow Y1 in FIG. 8 under a light source of approximately parallel light such as the sun light or the like during a period while the power source of the display device is OFF or during a period while a dark image such as a black image is displayed, the edge patterns of the dummy electrode 63 corresponding to the line 80 becomes recognizable.

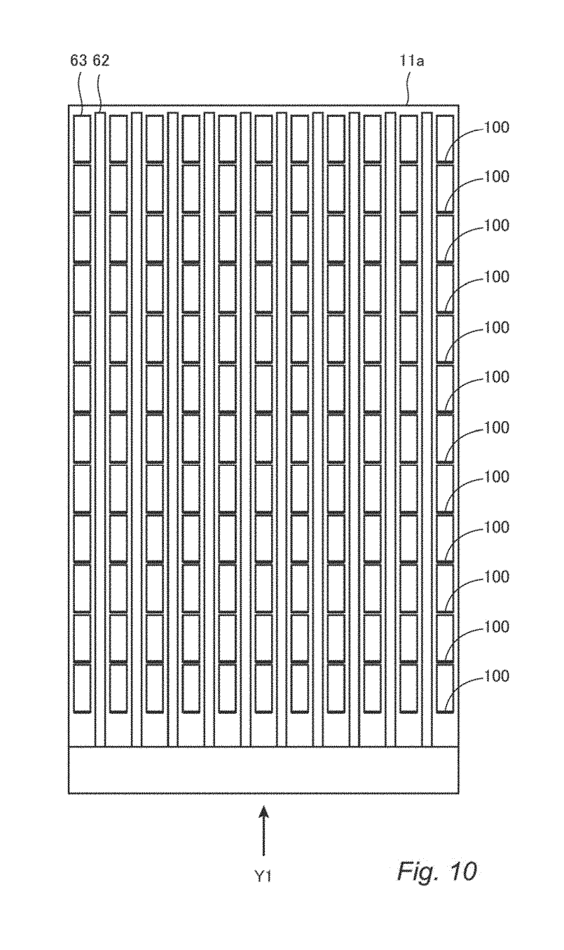

FIG. 10 is an image diagram illustrating edge patterns 100 of the dummy electrode 63 in a conventional touch sensor-equipped display device in which dummy electrodes 63 are divided by lines parallel to the X axis, the edge patterns 100 being visible when viewed in the direction indicated by the arrow Y1. As illustrated in FIG. 10, when viewed in the direction indicated by the arrow Y1, there is a possibility that the edge patterns 100 of a plurality of the dummy electrodes 63 are visible.

On the other hand, when viewed in the direction indicated by the arrow Y2 in FIG. 8, it seems that the pattern edges of the first direction linear portions 632a that compose the slit 632 of the dummy electrode 63 are visible, but these pattern edges of the first direction linear portions 632a are difficult to recognize, even when viewed by human eyes, since they are uniformly present. Likewise, when viewed in the direction indicated by the arrow Y3 in FIG. 8, these pattern edges of the second direction linear portions 632b composing the slit 632 of the dummy electrode 63 are difficult to recognize, even when viewed by human eyes, since they are uniformly present.

In the touch sensor-equipped display device of the present embodiment, therefore, the dummy electrode 63 is divided by dividing lines so that the dummy electrode 63 should not be provided across a plurality of the touch drive electrodes 61 arrayed in the Y axis direction, the dividing lines being lines parallel to either the first direction linear portions 632a or the second direction linear portions 632b that form the slit 632 in the zigzag shape. Particularly in the present embodiment, the dummy electrode 63 is divided by dividing lines that are obtained by extending either the first direction linear portions 632a or the second direction linear portions 632b of the linear portion slit 632.

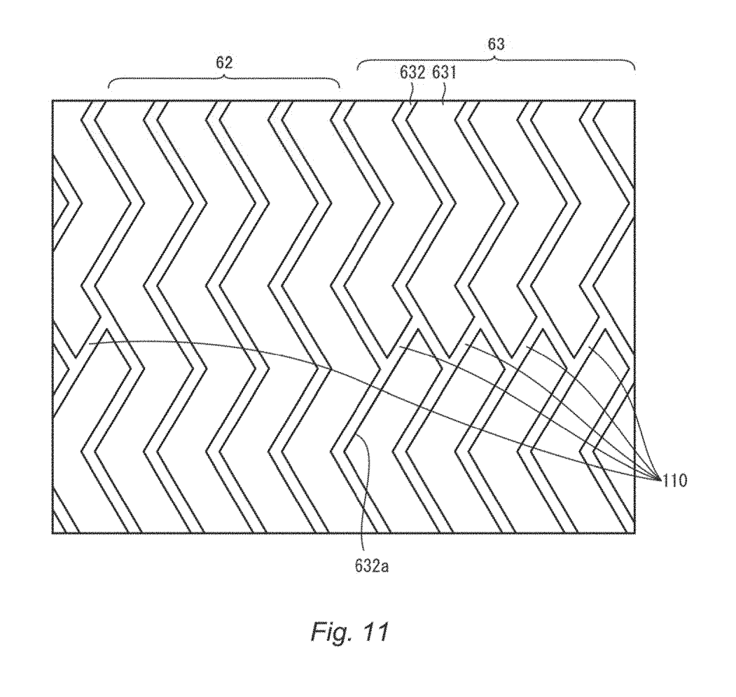

FIG. 11 illustrates dividing lines 110 of dummy electrodes 63 in the touch sensor-equipped display device in the present embodiment. The lines 110, which are lines obtained by extending the first direction linear portions 632a composing the slit 632 of the dummy electrode 63, are dividing lines that divide the dummy electrode 63. As described with reference to FIG. 8, this makes the dividing lines of the dummy electrode 63 difficult to recognize. The dummy electrode 63, however, may be divided by dividing lines obtained by extending the second direction linear portions 632b composing the slit 632.

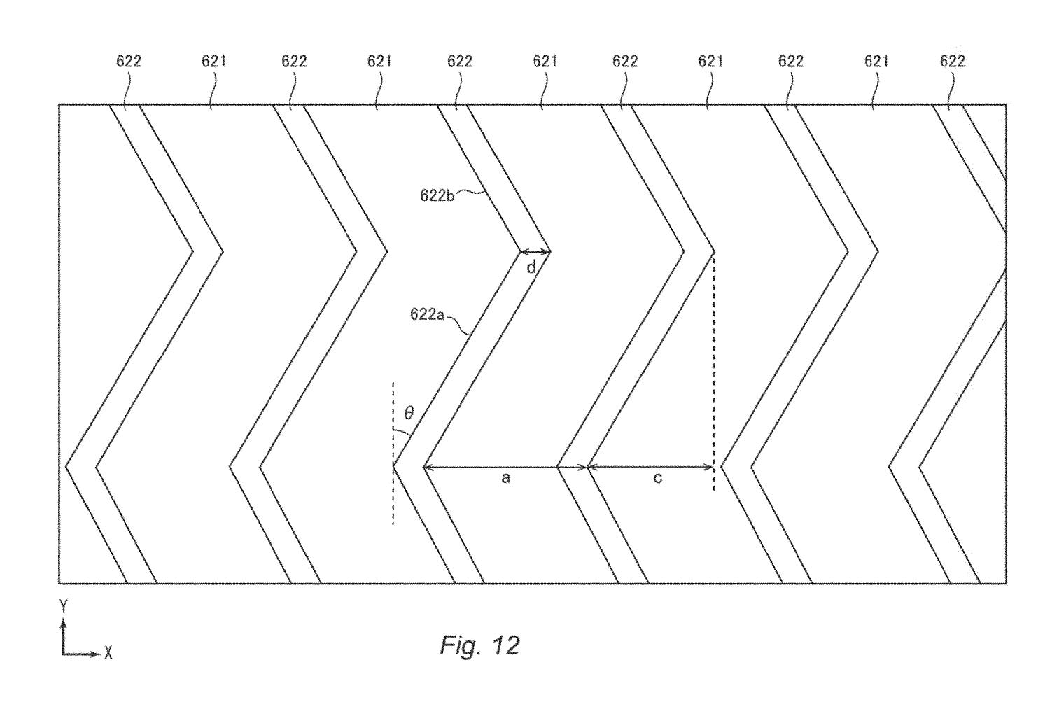

As described above, slits are provided not only in the dummy electrodes 63 but also in the touch detection electrodes 62. FIG. 12 is a diagram for explaining the shape of the slits provided in the touch detection electrode 62.

The touch detection electrode 62 is composed of a plurality of electrode portions 621 formed with translucent conductive films, and a plurality of slits 622 provided between the plurality of electrode portions 621. Each slit 622 is repeatedly bent in a zigzag shape, while extending in the Y axis direction in a plan view. In other words, each slit 622 is composed of first direction linear portions 622a extending in a first direction, and second direction linear portions 622b extending in a second direction that is different from the first direction. Here, the first direction linear portions 622a and the second direction linear portions 622b have the same width in the X axis direction, and the same length in the Y axis direction.

In the present embodiment, an arrangement interval “a” for the slits 622 adjacent in the X axis direction in a plan view satisfies the relationship given as the following expression (1):

a=b×(0.725+n)×√3÷(2×cos θ) (1)

where “b” represents an interval for a plurality of the display pixels adjacent in the X axis direction in a plan view, “θ” represents an angle of the slit 622 with respect to the Y axis direction as a reference direction, and “n” represents an integer equal to or greater than 0 (n=0, 1, 2, . . . ).

Further, the tumback width “c” of the slit 622 in the zigzag shape is set to (the distance between the centers of the subpixels adjacent in the X axis direction among the plurality of subpixels composing one display pixel)×{a natural number equal to or greater than (the number of colors of the subpixels+1)}. The tumback width “c” of the slit 622 is a width of the first direction linear portion 622a (or the second direction linear portion 622b) in the X axis direction. For example, in a case where the subpixels correspond to the three colors of R (red), G (green), and B (blue), the tumback width “c” of the slit 622 is assumed to be {(the distance between the centers of the subpixels)×(a natural number equal to or greater than 4)}. In the present embodiment, the tumback width “c” of the slit 622 is set to {(the distance between the centers of the subpixels)×4}.

It is preferable that the width “d” of the slit 622 in the X axis direction is 20 Lm or less. Further, it is preferable that the arrangement interval “a” of the slits 622 adjacent in the X axis direction is 175 μm or less.

The angle θ of the slit 622 is preferably 25° to 45°, and is set to 30° in the present embodiment.

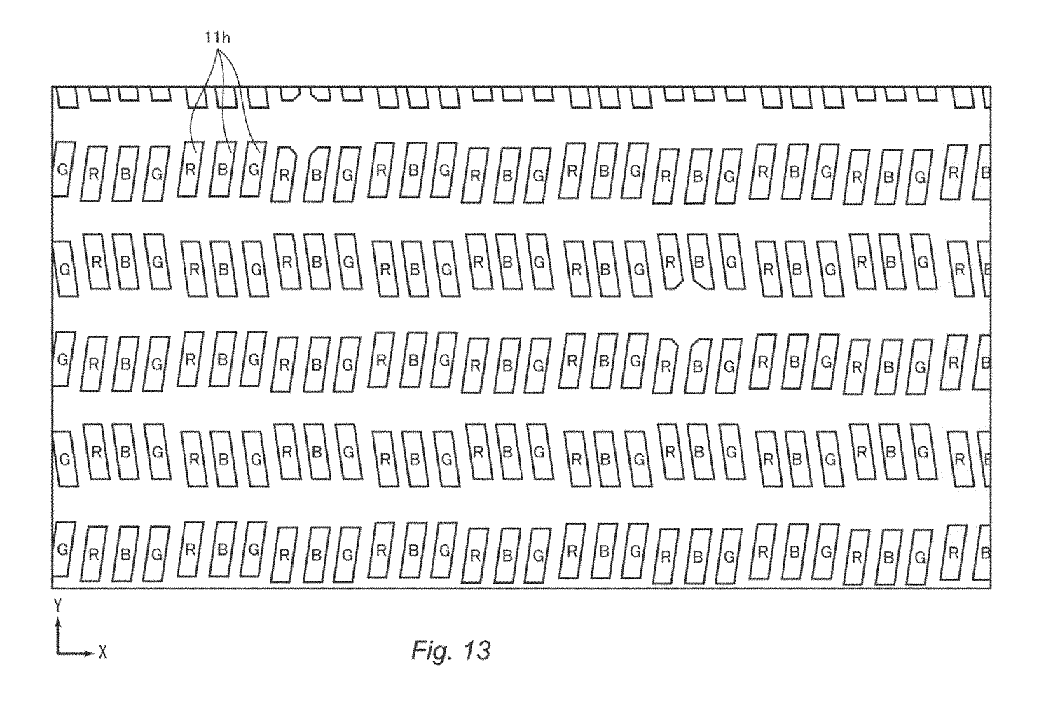

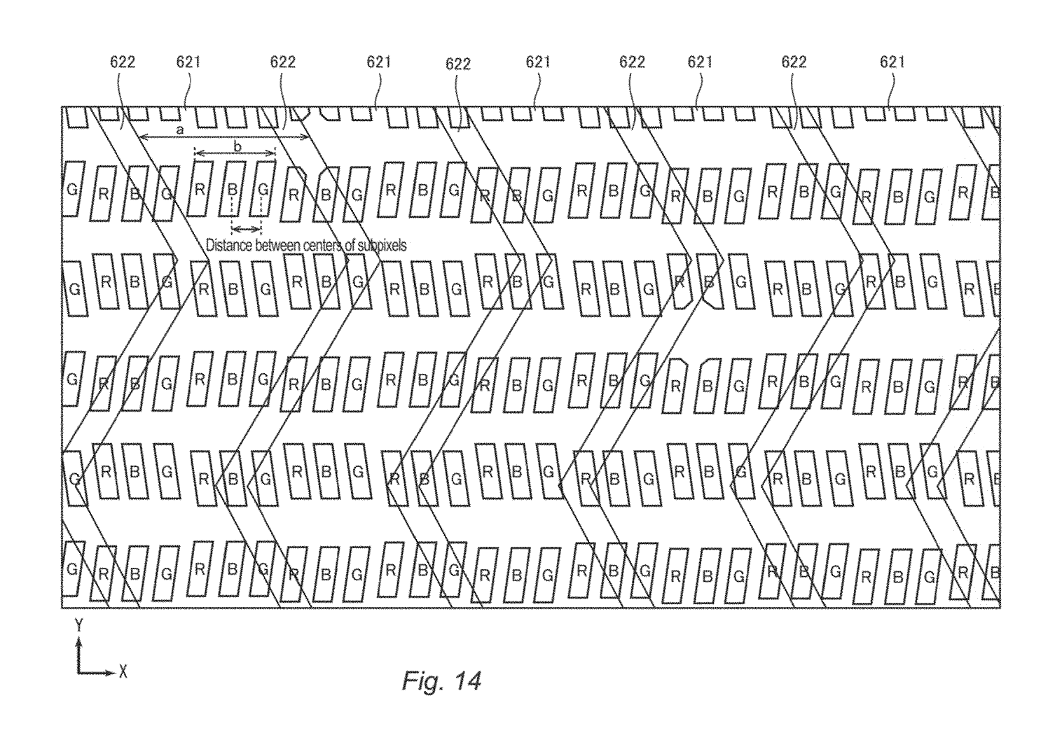

FIG. 13 illustrates one exemplary arrangement of color filters 11h. Further, FIG. 14 is a diagram obtained by superposing the diagram of a configuration of the touch detection electrode 62 illustrated in FIG. 12, on the diagram of color filter arrangement illustrated in FIG. 13. FIG. 14 illustrates the arrangement interval “a” for the slits 622, and the arrangement interval “b” for the display pixels as well. It should be noted that the arrangement interval “a” for the slits 622 is the interval in a case where n=1 and θ=30° in the expression (1), that is, 1.725 times the arrangement interval “b” for the display pixels.

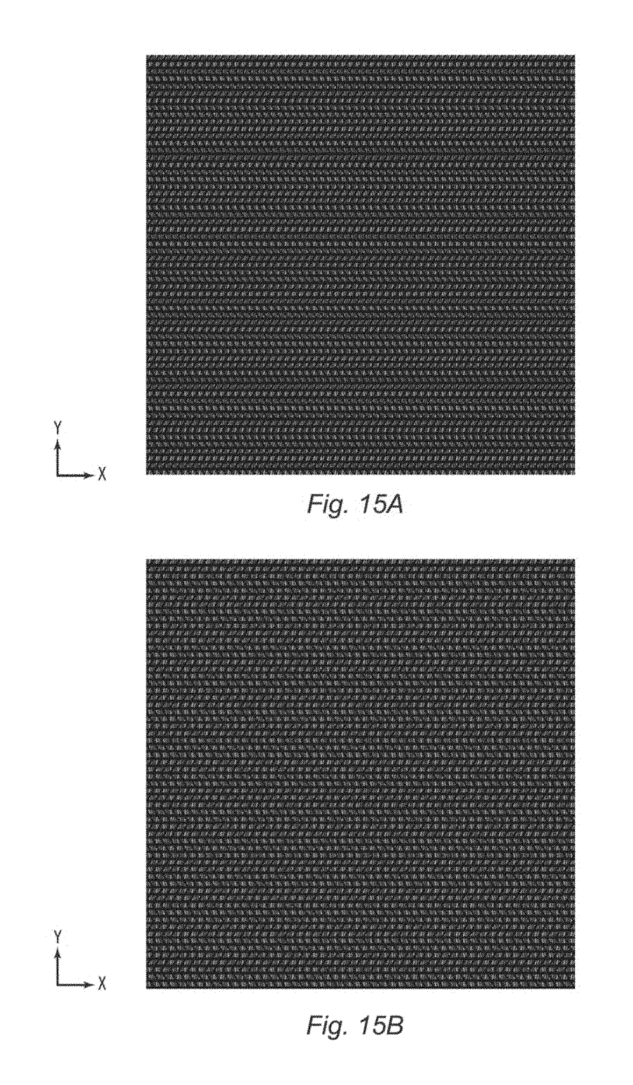

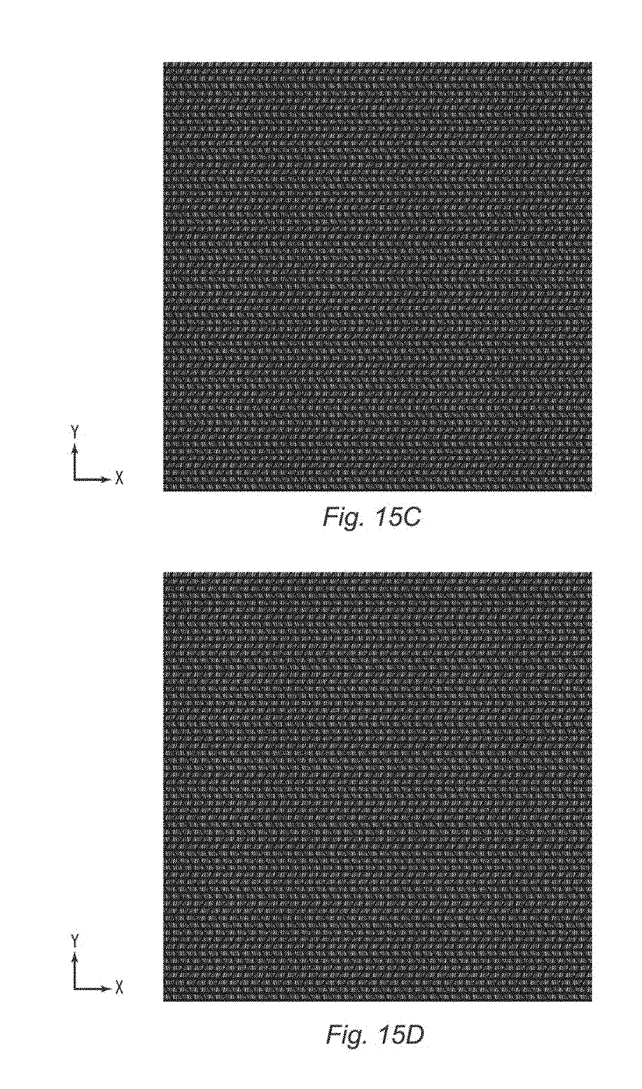

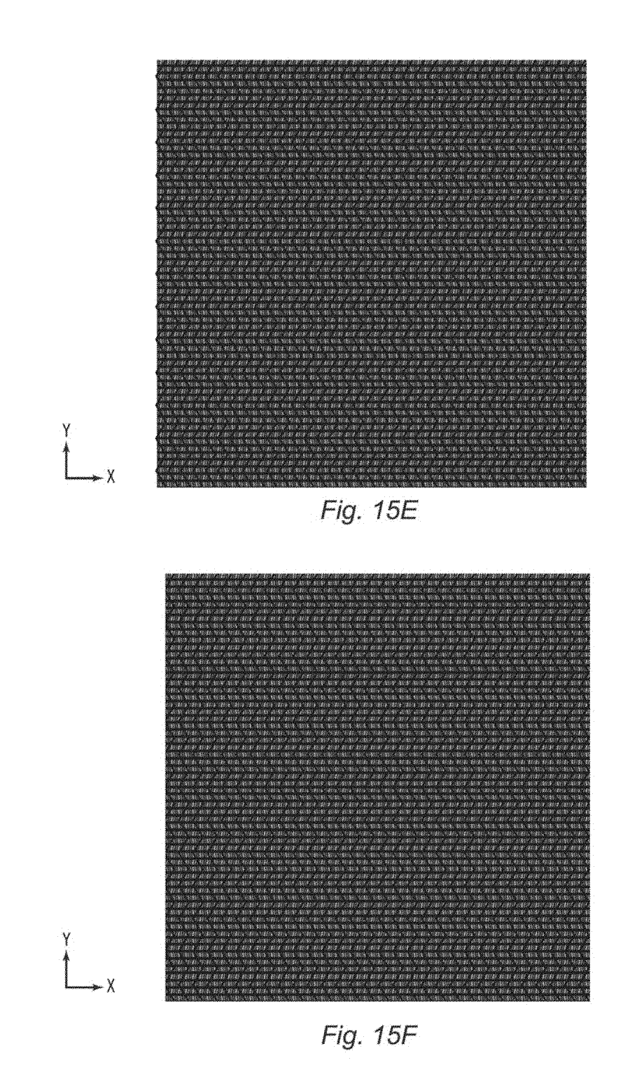

FIGS. 15A to 15F illustrate differences in appearance of the display screen when the arrangement interval “a” for the slits 622 is varied with respect to the arrangement interval “b” for the display pixels. Each of FIGS. 15A to 15F is an enlarged view illustrating a part of the display screen when white color display is performed in the entire display screen. In FIGS. 15A to 15F, the arrangement interval “a” for the slits 622 is set to 1.000 time, 1.225 times, 1.250 times, 1.500 times, 1.725 times, and 2.000 times the arrangement interval “b” for the display pixels, respectively.

In the case where the arrangement interval “a” for the slits 622 is set to 1.000 time the arrangement interval “b” for the display pixels, wide horizontal lines are visible as moire, as illustrated in FIG. 15A. In the case where the arrangement interval “a” for the slits 622 is set to 1.225 times or 1.250 times the arrangement interval “b” for the display pixels, thin diagonal lines are visible as moire, as illustrated in FIG. 15B or FIG. 15C. In the case where the arrangement interval “a” for the slits 622 is set to 1.500 times or 2.000 times the arrangement interval “b” for the display pixels, wide horizontal lines are visible as moire, as illustrated in FIG. 15D or FIG. 15F.

On the other hand, in the case where the arrangement interval “a” for the slits 622 is set to 1.725 times the arrangement interval “b” for the display pixels so as to satisfy the relationship given as the expression (1), clear moire is not seen as illustrated in FIG. 15E.

FIG. 15E illustrates the appearance of the display screen when the arrangement interval “a” for the slits 622 is set so as to satisfy the expression (1) and white color display is performed in the entire display screen. The following also describes the appearance of the display screen in a case where the arrangement interval “a” for the slits 622 is set so as to satisfy the following expression (1), and display other than the white color display is performed.

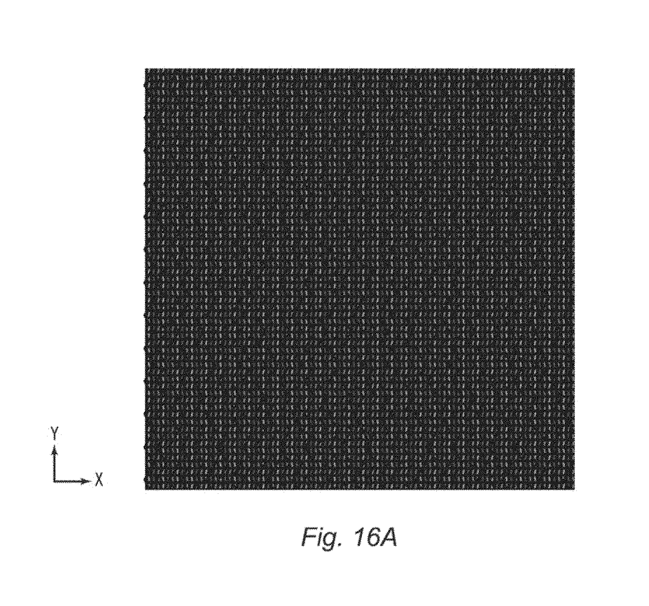

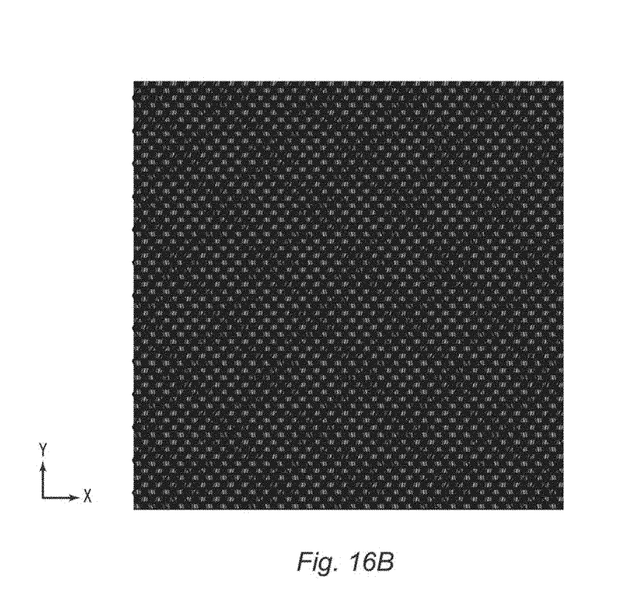

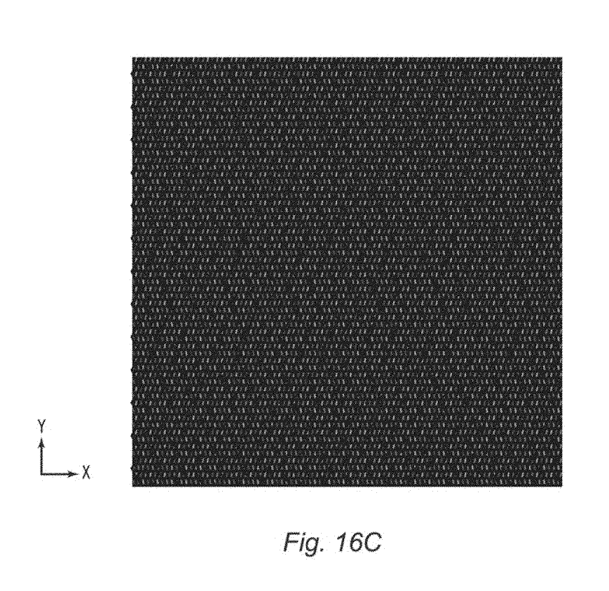

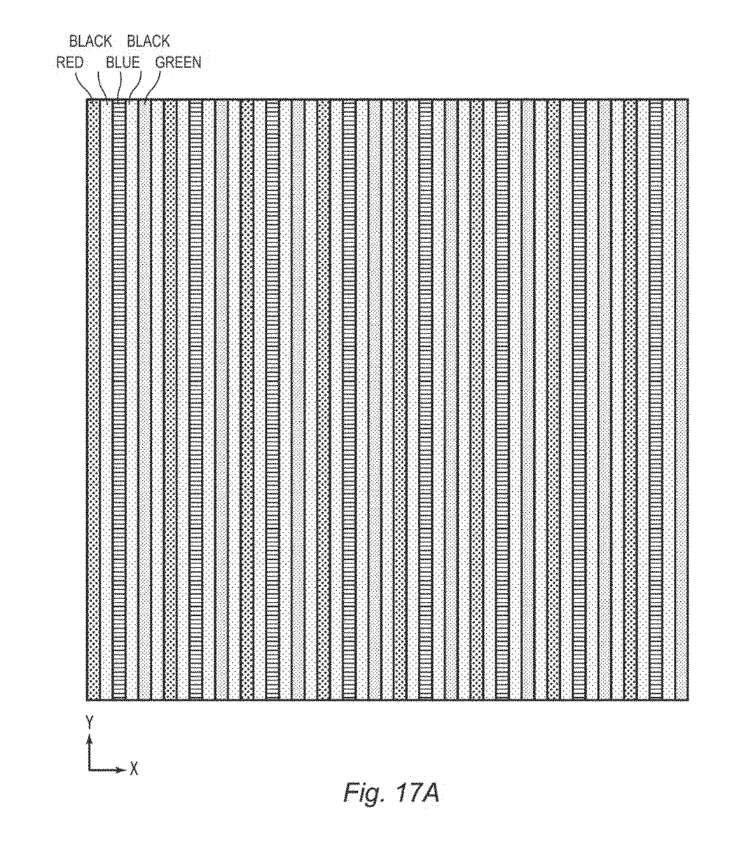

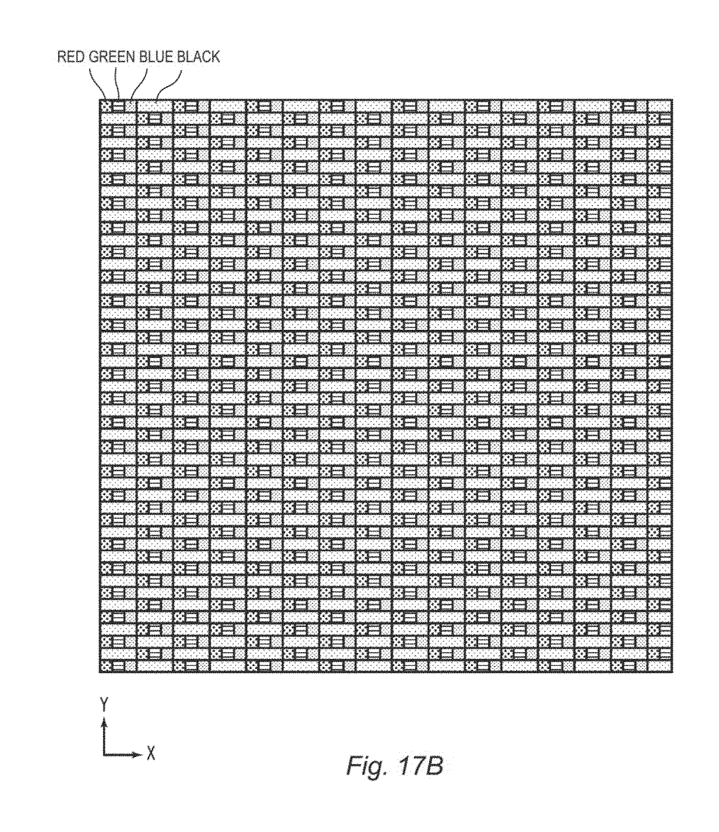

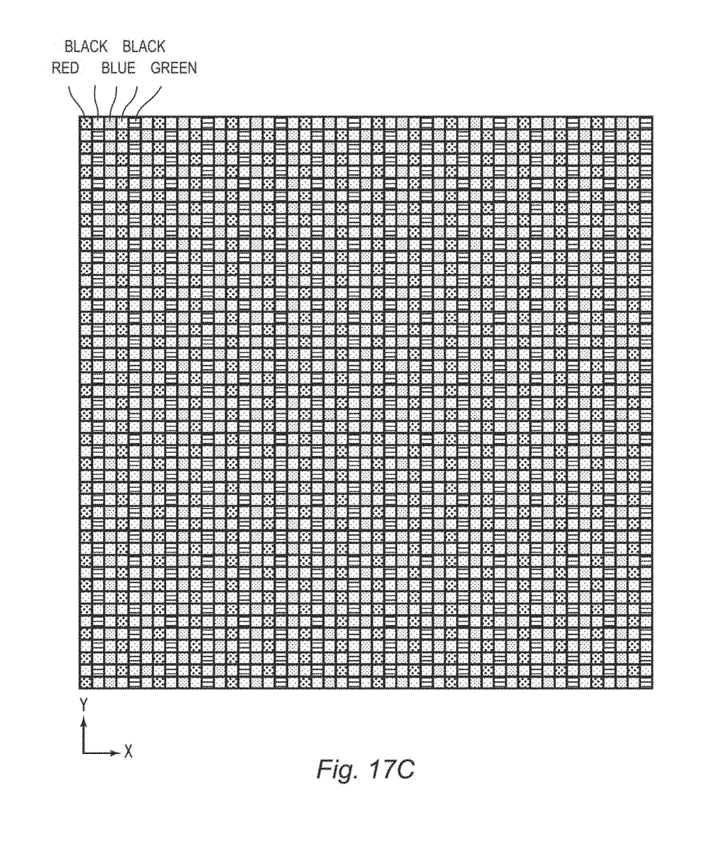

FIGS. 16A to 16C are enlarged views illustrating a part of the display screen in cases where the arrangement interval “a” for the slits 622 is set so as to satisfy the expression (1) and displays illustrated in FIGS. 17A to 17C are performed. Here, also, the arrangement interval “a” for the slits 622 is set to the interval in the case where n=1 and θ=30° in the expression (1), that is, set to 1.725 times the arrangement interval “b” for the display pixels.

FIG. 16A illustrates a display screen in a case where a black-and-white vertical stripe display is performed (corresponding to FIG. 17A), FIG. 16B illustrates a display screen in a case where a black-and-white chessboard pattern display is performed (corresponding to FIG. 17B), and FIG. 16C illustrates a display screen in a case where an RGB chessboard pattern display is performed (corresponding to FIG. 17C). In a case where the arrangement interval “a” for the slits 622 is set so as to satisfy the expression (1), clear moire is not seen, in any one of the case where the black-and-white vertical stripe display (FIG. 16A) is performed, the case where the black-and-white chessboard pattern display (FIG. 16B) is performed, and the case where the RGB chessboard pattern display (FIG. 16C) is performed, as is the case where white color display is performed in the entire display screen (FIG. 15E).

The present invention is not limited to the above-described embodiment. For example, the foregoing description refers to a liquid crystal panel as an exemplary display panel in which a display function layer including a plurality of display pixels arranged in matrix is provided between a pair of substrates, but the display panel may be another display panel such as an organic electroluminescence (EL) panel including organic EL elements.

The foregoing description refers to an example in which the dummy electrode 63 is divided by using, as the dividing lines, the lines obtained by extending the first direction linear portions 632a or the second direction linear portions 632b composing the slit 632 of the dummy electrode 63, but the dummy electrode 63 may be divided by using, as the dividing lines, the lines parallel to the first direction linear portions 632a or the second direction linear portions 632b composing the slit 632, whereby the dividing lines are difficult to recognize.

In the foregoing description, the colors of the subpixels are three colors of R (red), G (green), and B (blue), but the colors may be four colors of R (red), G (green), B (blue), and Y (yellow), or alternatively, five or more colors.

The touch sensor-equipped display device in the present embodiment is used in various types of electronic devices such as mobile phones (including smartphones), notebook computers (including tablet-type notebook computers), portable information terminals (including electronic books and PDAs), digital photoframes, and portable game machines.

### DESCRIPTION OF REFERENCE NUMERALS

10 . . . touch sensor-equipped display device
11 . . . touch sensor-equipped liquid crystal panel
11a . . . CF substrate
11b . . . array substrate
61 . . . touch drive electrode
62 . . . touch detection electrode
63 . . . dummy electrode
110 . . . dividing line
632 . . . slit in dummy electrode

1. A touch sensor-equipped display device comprising:
a display panel that includes:
a first substrate;
a second substrate opposed to the first substrate; and
a display function layer interposed between the first substrate and the second substrate, the display function layer including a plurality of display pixels arranged in matrix;
a plurality of touch drive electrodes arranged between the first substrate and the second substrate so as to be arrayed in a first direction, each of the touch drive electrodes extending in a second direction that intersects with the first direction at a right angle;
a plurality of touch detection electrodes arranged on a surface of the first substrate, the surface being on an opposite side with respect to the touch drive electrodes, so as to be arrayed in the second direction, each of the touch detection electrodes extending in the first direction; and
a dummy electrode arranged between adjacent ones of the touch detection electrodes,
wherein a slit is provided in the dummy electrode, the slit being repeatedly bent in a zigzag shape, while extending in the first direction, and
the dummy electrode is divided by, as a dividing line, a line parallel with either first edges or second edges, the first edges and the second edges forming the slit in the zigzag shape, so that the dummy electrode should not be provided across a plurality of the touch drive electrodes arrayed in the first direction.

2. The touch sensor-equipped display device according to claim 1,
wherein the dummy electrode is divided by, as a dividing line, a line obtained by extending either the first edge or the second edge, the first edges and the second edges forming the slit in the zigzag shape.
